(19) United States
(12) Patent Application Publication
(10) Pub. No.: US 2024/0279979 A1
(43) Pub. Date: Aug. 22, 2024

(54) Remote-Controlled Button-Pushing Device

(71) Applicants: Michael Whitens, Mukwonago, WI (US); Benjamin Wurtinger, Racine, WI (US)

(72) Inventors: Michael Whitens, Mukwonago, WI (US); Benjamin Wurtinger, Racine, WI (US)

(21) Appl. No.: 18/414,548

(22) Filed: Jan. 17, 2024

Related U.S. Application Data
(60) Provisional application No. 63/446,536, filed on Feb. 17, 2023.

(51) Int. Cl. E05F 15/77; E05F 15/668

(52) U.S. Cl. CPC E05F 15/77; E05F 15/668

(57) ABSTRACT

A remote-controlled button-pushing device is provided. The device can be positioned in front of a physical garage door control. The device has at least one actuator that can be remotely operated via a fob. In this manner, a user can use the fob to actuate the actuator such that the actuator presses a button on the garage door control to raise/lower the door.

### CROSS-REFERENCE TO RELATED APPLICATION

The present application claims priority to, and the benefit of, U.S. Provisional Application No. 63/446,536, which was filed on Feb. 17, 2023, and is incorporated herein by reference in its entirety.

### FIELD OF THE INVENTION

The present invention relates generally to the field of garage door opening devices. More specifically, the present invention relates to a remote-controlled button-pushing device that is fob-controlled and that can be positioned in front of a garage door control such that at least one motorized actuator of the device presses the open or closing buttons of the control. Accordingly, the present disclosure makes specific reference thereto. Nonetheless, it is to be appreciated that aspects of the present invention are also equally applicable to other like applications, devices, and methods of manufacture.

### BACKGROUND

Without an integrated system for remotely controlling shop bay garage doors, significant energy and time are expended every time a worker has to leave and re-enter their vehicle to manually operate said doors. This process of constant entering and exiting breaks the flow of work, creating inefficiencies and disrupting productivity. Moreover, this process contributes to increased heating and air conditioning expenses, as the duration of the doors being open is significantly increased, leading to a loss of controlled indoor climate. Such a situation is further aggravated during the colder winter months wherein the risk of slips, trips, and falls increase dramatically due to icy or slick surfaces commonly found around these areas. Navigating these hazardous conditions while maneuvering in and out of vehicles not only poses a threat to personal safety but also potentially leads to increased incidents of workplace injuries.

Therefore, there exists a long-felt need in the art for a device that allows a user to remotely open and close a garage door. There also exists a long-felt need in the art for a remote-controlled button-pushing device. More specifically, there exists a long-felt need in the art for a remote-controlled button-pushing device that allows a user to remotely open and close a garage door. Further, there exists a long-felt need in the art for a remote-controlled button-pushing device that allows a user to remotely open and close a garage door wherein the device can be retrofitted to any garage door with a physical garage door control.

The subject matter disclosed and claimed herein, in one embodiment thereof, comprises a remote-controlled button-pushing device. The device can be positioned in front of a physical garage door control. The device has at least one actuator that can be remotely operated via a fob. In this manner, a user can use the fob to actuate the actuator such that the actuator presses a button on the garage door control to raise/lower the door.

In this manner, the remote-controlled button-pushing device of the present invention accomplishes all the foregoing objectives and provides a device that allows a user to remotely open and close a garage door. More specifically, the device allows a user to remotely open and close a garage door. Further, the device can be retrofitted to any garage door with a physical garage door control.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a remote-controlled button-pushing device. The device is comprised of a housing with at least one motorized actuator that can be remotely controlled via at least one fob with at least one button. During use, the device is positioned in front of a garage door control such that the actuators can be remotely activated to press the open button and close button of the control.

The device is comprised of a housing that may be any shape, size, and configuration. The housing is comprised of at least one motorized actuator that can extend from/retract towards the housing during use. The actuator is powered by at least one battery.

During use, the device is positioned in front of a garage door control such that the actuator can extend from the housing and physically depress the opening button and closing button of the control to open/close the garage door the control operates. In order to secure the housing in this position, the device may be comprised of at least one mounting structure that may be comprised of at least one magnet.

The movement of the actuators can be controlled remotely via at least one fob. At least one transmitter of the fob is in wireless electrical communication (i.e., Wi-Fi, Bluetooth, RFID, etc.) with at least one receiver of the housing. In the preferred embodiment, the device has two actuators, one actuator designated for pushing the open button on the garage door control, and one actuator designated for pushing the close button on the garage door control. In this embodiment, the fob is comprised of at least one button. When pressed, a first button activates the first actuator to press the open button and a second button activates the second actuator that presses the close button.

The present invention is also comprised of a method of using the device. First, a device is provided comprised of a fob comprised of at least one transmitter and at least one button, and a housing comprised of at least one actuator, at least one battery, and at least one receiver. Then, the housing can be positioned near a garage door control by attaching the mounting structure to a structure or surface via at least one fastener and/or at least one magnet. Then, a first button of the fob can be pressed such that a first actuator presses the open button on the garage door control. Finally, a second button of the fob can be pressed such that a second actuator presses the close button on the garage door control.

The present invention is also comprised of a second method of using the device. First, a device is provided comprised of a mobile application and a housing comprised of at least one actuator, at least one battery, and at least one receiver. Then, the housing can be positioned near a garage door control by attaching the mounting structure to a structure or surface via at least one fastener and/or at least one magnet. Then, the application can be used to control/activate the actuators such that a first actuator presses the open button on the garage door control and a second actuator presses the close button on the garage door control.

Accordingly, the remote-controlled button-pushing device of the present invention is particularly advantageous as it provides a device that allows a user to remotely open and close a garage door. More specifically, the device allows a user to remotely open and close a garage door. Further, the device can be retrofitted to any garage door with a physical garage door control. In this manner, the remote-controlled button-pushing device provides a universal solution for remotely operating any garage door with a physical control.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of a remote-controlled button-pushing device of the present invention while positioned in front of a garage door control in accordance with the disclosed architecture;

FIG. 2 illustrates a front perspective view of one potential embodiment of a remote-controlled button-pushing device of the present invention while positioned in front of a garage door control in accordance with the disclosed architecture;

FIG. 3 illustrates a side perspective view of one potential embodiment of a remote-controlled button-pushing device of the present invention while positioned in front of a garage door control in accordance with the disclosed architecture;

FIG. 4 illustrates a top view of a fob of one potential embodiment of a remote-controlled button-pushing device of the present invention in accordance with the disclosed architecture;

FIG. 5 illustrates a graphical view of a features of a mobile application of one potential embodiment of a remote-controlled button-pushing device of the present invention in accordance with the disclosed architecture;

FIG. 6 illustrates a flowchart of a method of using one potential embodiment of a remote-controlled button-pushing device of the present invention in accordance with the disclosed architecture; and

FIG. 7 illustrates a flowchart of a method of using one potential embodiment of a remote-controlled button-pushing device of the present invention in accordance with the disclosed architecture;

FIG. 8 illustrates a side perspective view of one potential embodiment of a remote-controlled button-pushing device of the present invention while attached to a garage door control via at least one mounting bracket in accordance with the disclosed architecture; and

FIG. 9 illustrates a side perspective view of one potential embodiment of a remote-controlled button-pushing device of the present invention while attached to a garage door control via at least one mounting bracket in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to remotely open and close a garage door. There also exists a long-felt need in the art for a remote-controlled button-pushing device. More specifically, there exists a long-felt need in the art for a remote-controlled button-pushing device that allows a user to remotely open and close a garage door. Further, there exists a long-felt need in the art for a remote-controlled button-pushing device that allows a user to remotely open and close a garage door wherein the device can be retrofitted to any garage door with a physical garage door control.

The present invention, in one exemplary embodiment, is comprised of a remote-controlled button-pushing device. The device is comprised of a housing with at least one motorized actuator that can be remotely controlled via at least one fob with at least one button. During use, the device is positioned in front of a garage door control such that the actuators can be remotely activated to press the open button and close button of the control.

The device is comprised of a housing that may be any shape, size, and configuration. The housing is comprised of at least one motorized actuator that can extend from/retract towards the housing during use. The actuator is powered by at least one battery.

During use, the device is positioned in front of a garage door control. In this manner, at least one actuator can extend from the housing and physically depress the opening button and closing button of the control to open/close the garage door the control operates. In order to secure the housing in this position, the device may be comprised of at least one mounting structure that may be comprised of at least one magnet.

In one embodiment, the movement of the actuators can be controlled remotely via at least one fob. At least one transmitter of the fob is in wireless electrical communication (i.e., Wi-Fi, Bluetooth, RFID, etc.) with at least one receiver of the housing. In the preferred embodiment, the device has two actuators, one actuator designated for pushing the open button on the garage door control, and one actuator designated for pushing the close button on the garage door control. In this embodiment, the fob is comprised of at least one button. When pressed, a first button activates the first actuator to press the open button and a second button activates the second actuator that presses the close button.

The present invention is also comprised of a method of using the device. First, a device is provided comprised of a fob comprised of at least one transmitter and at least one button, and a housing comprised of at least one actuator, at least one battery, and at least one receiver. Then, the housing can be positioned near a garage door control by attaching the mounting structure to a structure or surface via at least one fastener and/or at least one magnet. Then, a first button of the fob can be pressed such that a first actuator presses the open button on the garage door control. Finally, a second button of the fob can be pressed such that a second actuator presses the close button on the garage door control.

The present invention is also comprised of a second method of using the device. First, a device is provided comprised of a mobile application and a housing comprised of at least one actuator, at least one battery, and at least one receiver. Then, the housing can be positioned near a garage door control by attaching the mounting structure to a structure or surface via at least one fastener and/or at least one magnet. Then, the application can be used to control/activate the actuators such that a first actuator presses the open button on the garage door control and a second actuator presses the close button on the garage door control.

Accordingly, the remote-controlled button-pushing device of the present invention is particularly advantageous as it provides a device that allows a user to remotely open and close a garage door. More specifically, the device allows a user to remotely open and close a garage door. Further, the device can be retrofitted to any garage door with a physical garage door control. In this manner, the remote-controlled button-pushing device provides a universal solution for remotely operating any garage door with a physical control.

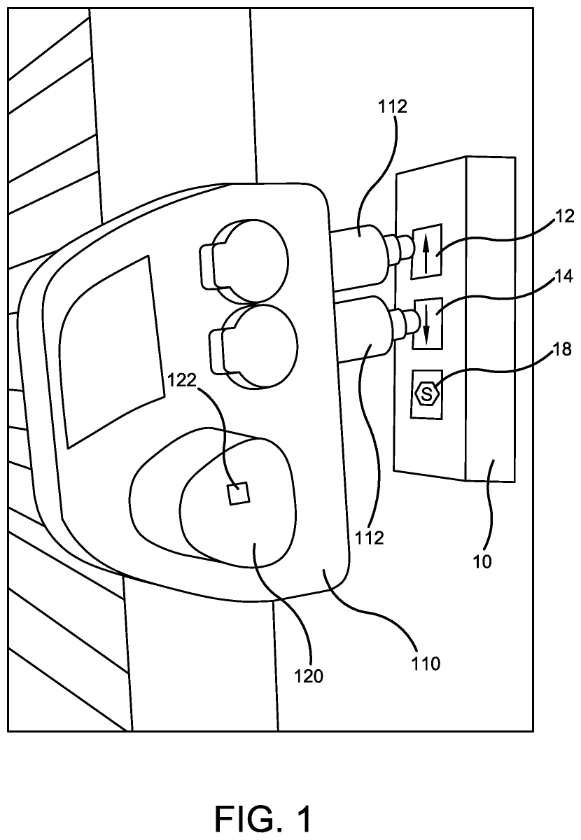

Referring initially to the drawings, FIG. 1 illustrates a side perspective view of one potential embodiment of a remote-controlled button-pushing device of the present invention while positioned in front of a garage door control in accordance with the disclosed architecture. The device 100 is comprised of a housing 110 with at least one motorized actuator 112 that can be remotely controlled via at least one fob 150 with at least one button 154,156. During use, the device 100 is positioned in front of a garage door control 10 such that the actuators can be remotely activated to press the open button 12 and close button 14 of the control 10.

The device 100 is comprised of a housing 110 that may be any shape, size, and configuration. The housing 110 is comprised of at least one motorized actuator 112. The actuator 112 can extend from/retract towards the housing 110 during use. The actuator 112 may be any size, type, and configuration of actuator known in the art.

The actuator 112 is powered by at least one battery 120. In one embodiment, the battery 120 may be rechargeable or disposable. In another embodiment, the battery 120 is removable or non-removable from the housing 110. The battery 120 may be comprised of at least one charging port 122 that allows the battery 120 to be recharged. The port 122 may be any battery charging port such as, but not limited to, USB or contact charging ports.

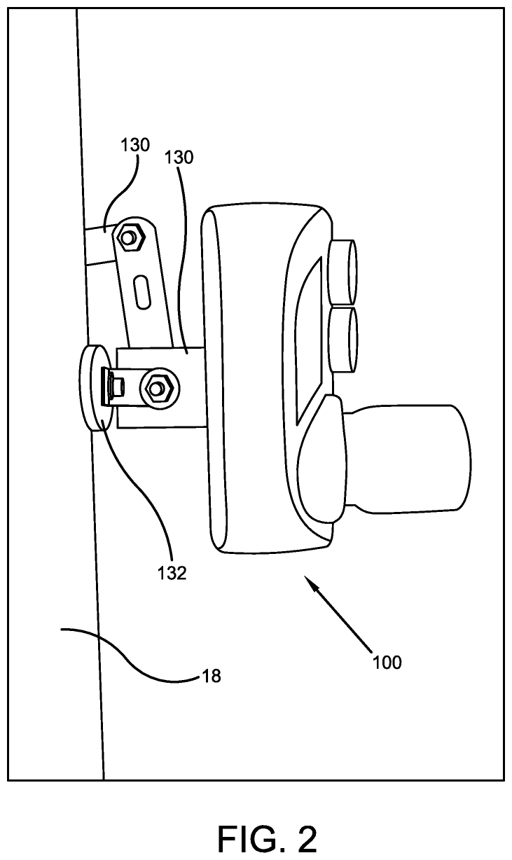

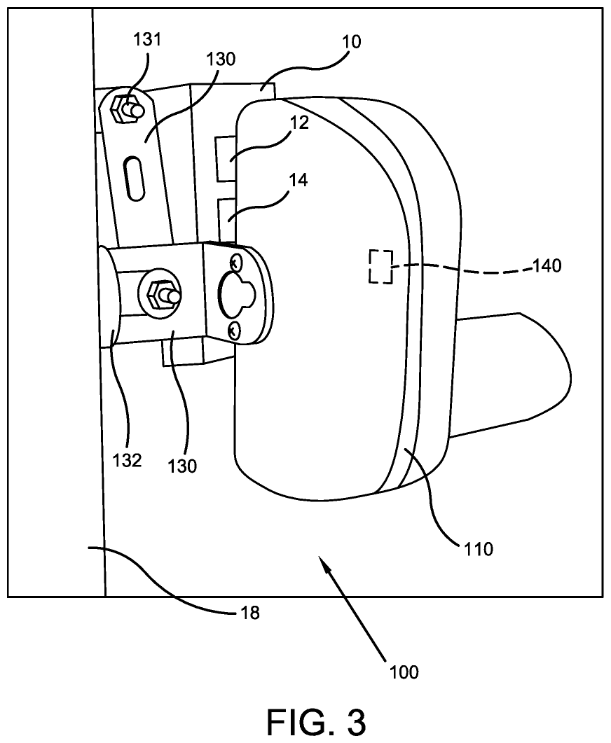

During use, the device 100 is positioned in front of a garage door control 10 such that the actuator 112 can extend from the housing 110 and physically depress the opening button 12 and closing button 14 of the control 10 to open/close the garage door 16 the control 10 operates. In one embodiment, the actuator 112 may also depress the stop button 18. In order to secure the housing 110 in this position, the device 100 may be comprised of at least one mounting structure 130, as seen in FIG. 2 and FIG. 3. The structure 130 may include, but is not limited to, a mounting arm, a mounting bracket, etc. In this manner, the housing 110 can be mounted to surfaces such as, but not limited to, a garage door track 18, a garage door frame, a wall or other surface, etc., via at least one fastener 131 such as, but not limited to, a screw, a bolt, etc. In another embodiment, the mounting structure 130 (or any other area of the device 100) may be comprised of at least one magnet 132. The magnet 132 allows the housing 110 to be further secured to a metal surface, such as, but not limited to, a metal garage door track 18.

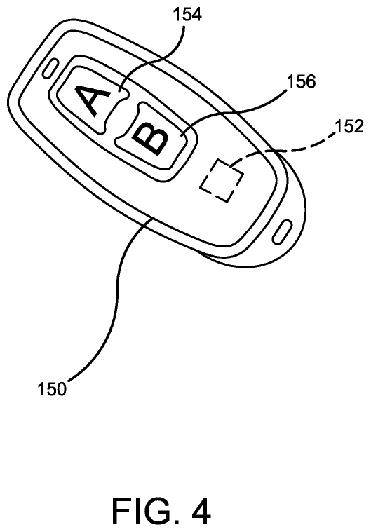

The movement of the actuators 112 can be controlled remotely via at least one fob 150, as seen in FIG. 4. In another embodiment, the actuators 112 can be controlled by at least one button/switch/lever 180. At least one transmitter 152 of the fob 150 is in wireless electrical communication (i.c., Wi-Fi, Bluetooth, RFID, etc.) with at least one receiver 140 of the housing 110. In the preferred embodiment, the device 100 has two actuators 112, one actuator 112 designated for pushing the open button 12 on the garage door control 10, and one actuator 112 designated for pushing the close button 14 on the garage door control 10. In this embodiment, the fob 150 is comprised of at least one button 154,156. When pressed, a first button 154 activates the first actuator 112 to press the open button 12 and a second button 156 activates the second actuator 112 that presses the close button 156.

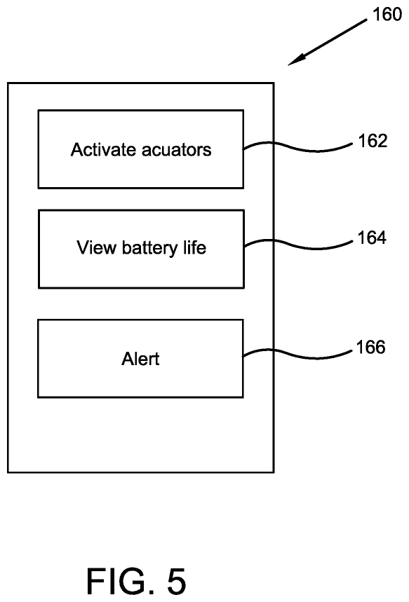

In one embodiment, the device 100 is comprised of a mobile application 160 (as seen in FIG. 5) that can be installed on a smart device such as, but not limited to, a cell phone, a tablet, a computer, The mobile application 160 allows a user activate 162 the actuators 112. The application 160 may also allow a user to view the battery life 164 of the battery 120. Finally, the application 160 may notify a user via a text, a call, an email, a push notification, etc., each time the buttons 12,14 of the control 10 are pressed by the actuators 112.

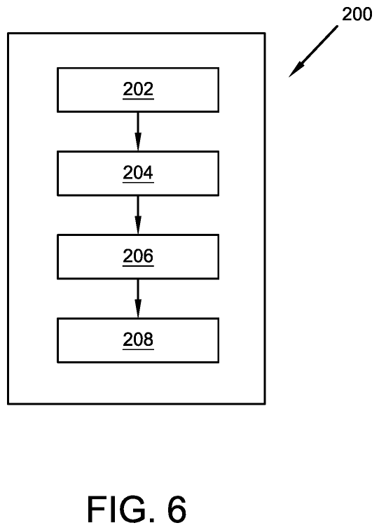

The present invention is also comprised of a method of using 200 the device 100, as seen in FIG. 6. First, a device 100 is provided comprised of a fob 150 comprised of at least one transmitter 152 and at least one button 154,156 and a housing 110 comprised of at least one actuator 112, at least one battery 120, and at least one receiver 140 [Step 202]. Then, the housing 110 can be positioned near a garage door control 10 by attaching the mounting structure 130 to a structure or surface via at least one fastener 131 and/or at least one magnet 132 [Step 204]. Then, a first button 154 of the fob 150 can be pressed such that a first actuator 112 presses the open button 12 on the garage door control 10 [Step 206]. Finally, a second button 156 of the fob 150 can be pressed such that a second actuator 112 presses the close button 14 on the garage door control 10 [Step 208].

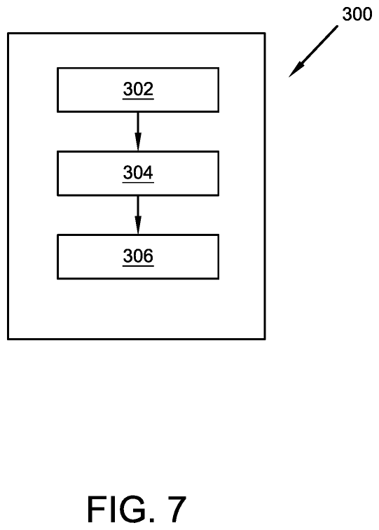

The present invention is also comprised of a second method of using 300 the device 100, as seen in FIG. 7. First, a device 100 is provided comprised of a mobile application 160 and a housing 110 comprised of at least one actuator 112, at least one battery 120, and at least one receiver 140 [Step 302]. Then, the housing 110 can be positioned near a garage door control 10 by attaching the mounting structure 130 to a structure or surface via at least one fastener 131 and/or at least one magnet 132 [Step 304]. Then, the application 160 can be used to control/activate the actuators 112 such that a first actuator 112 presses the open button 12 on the garage door control and a second actuator 112 presses the close button 14 on the garage door control 10 [Step 306].

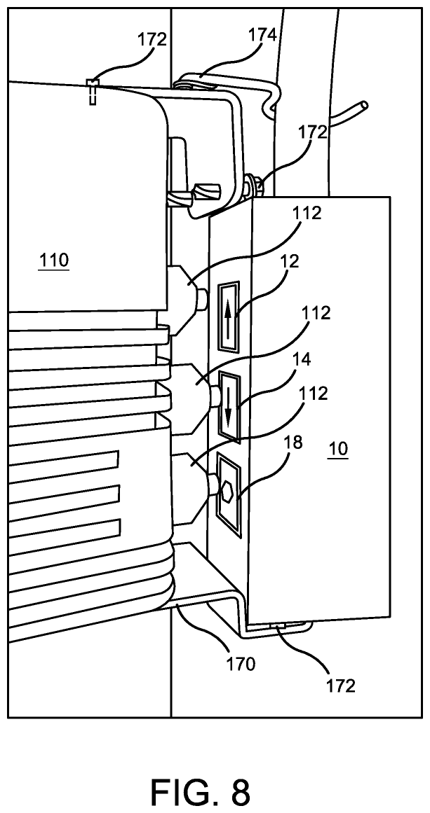

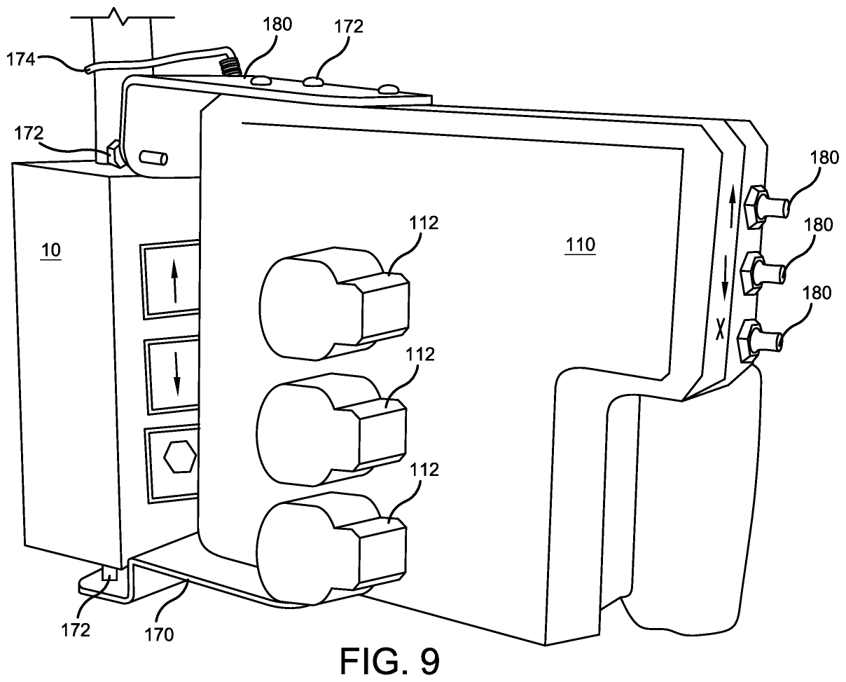

In one embodiment, the device 100 may be attached directly to/on a garage door control 10. In this embodiment, the housing 110 attaches to/around/on the control 10 via at least one mounting bracket 170, as seen in FIG. 8 and FIG. 9. The bracket 170 may be any shape, size, and configuration in order to attach to the housing 110 and control 10. In one embodiment, the bracket 170 attaches to a control 10 and/or housing 110 via at least one fastener 172 such as but not limited to a screw, a bolt, a magnet, etc. In one embodiment, the bracket 170 may be comprised of at least one additional fastener 174, such as but not limited to a hook that further allows the housing 110 to attach to a control 10 or any associated structures of the control 10 for additional stability.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “remote-controlled button-pushing device” and “device” are interchangeable and refer to the remote-controlled button-pushing device 100 of the present invention.

Notwithstanding the foregoing, the remote-controlled button-pushing device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the remote-controlled button-pushing device 100 as shown in the FIGS. are for illustrative purposes only, and that many other sizes and shapes of the remote-controlled button-pushing device 100 are well within the scope of the present disclosure. Although the dimensions of the remote-controlled button-pushing device 100 are important design parameters for user convenience, the remote-controlled button-pushing device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A remote-controlled button-pushing device comprising:
a housing comprised of a first actuator;
a battery;
a receiver;
a mounting structure; and
a fob comprised of a transmitter and a button.

2. The remote-controlled button-pushing device of claim 1, wherein the transmitter is in wireless electrical communication with the receiver.

3. The remote-controlled button-pushing device of claim 1, wherein the button extends or retracts the actuator from the housing when pressed.

4. The remote-controlled button-pushing device of claim 1, wherein the actuator is comprised of a motorized actuator.

5. The remote-controlled button-pushing device of claim 1, wherein the mounting structure is comprised of a magnet.

6. The remote-controlled button-pushing device of claim 1, wherein the battery is removable.

7. The remote-controlled button-pushing device of claim 1, wherein the battery is rechargeable.

8. The remote-controlled button-pushing device of claim 1 further comprised of a second actuator.

9. A remote-controlled button-pushing device comprising:
a housing comprised of a first actuator;
a battery;
a receiver;
a mounting structure; and
a mobile application.

10. The remote-controlled button-pushing device of claim 9, wherein the receiver is in wireless electrical communication with a smart device the mobile application is installed on.

11. The remote-controlled button-pushing device of claim 9, wherein the mobile application allows a user to extend or retract the actuator from the housing when pressed.

12. The remote-controlled button-pushing device of claim 9, wherein the actuator is comprised of a motorized actuator.

13. The remote-controlled button-pushing device of claim 9, wherein the mounting structure is comprised of a magnet.

14. The remote-controlled button-pushing device of claim 9, wherein the battery is removable.

15. The remote-controlled button-pushing device of claim 9, wherein the battery is rechargeable.

16. The remote-controlled button-pushing device of claim 9 further comprised of a second actuator.

17. A method of using a remote-controlled button-pushing device, the method comprising the following steps:
providing a remote-controlled button-pushing device comprised of a housing comprised of an actuator, a battery, and a receiver;
positioning the housing near a garage door control; and
activating the actuator such that the actuator extends from the housing and depressing an open button or a close button of the garage door control.

18. The method of using a remote-controlled button-pushing device of claim 17, wherein the actuator is controlled by a fob.

19. The method of using a remote-controlled button-pushing device of claim 17, wherein the actuator is controlled by a mobile application.

20. The method of using a remote-controlled button-pushing device of claim 17, wherein the remote-controlled button-pushing device is comprised of a mounting structure.
